(19) United States
(12) Patent Application Publication
(10) Pub. No.: US 2014/0355760 A1
(43) Pub. Date: Dec. 4, 2014

(54) Method of Third Party Identification for Cryptographic Communications

(71) Applicant: Chiou-Haun Lee, Taichung (TW)

(72) Inventor: Chiou-Haun Lee, Taichung (TW)

(21) Appl. No.: 13/905,165

(22) Filed: May 30, 2013

(51) Int. Cl. H04N 1/44; G06F 21/60

(52) U.S. Cl. CPC H04N 1/4486; G06F 21/602
USPC 380/243

(57) ABSTRACT

The invention is aimed to work on XOR operation safely in cryptographic communications with third party identification, wherein a sender in FIG. 1B encrypts an 1D plaintext with a 2D authorized image to get two ciphertexts, such that, one is sent directly to a receiver and the other is forwarded via a third party to the receiver, wherein the receiver recovers the plaintext just by XORing two ciphertexts. For transmission security, according to FIG. 2, the third party sends privately two different authorized images for building each separate secure channel linked to a sender and to a receiver; furthermore, at one channel from the sender to the third party, the forwarded ciphertext is re-encrypted with a random code and then sent to the third party; at the other channel from the third party to the receiver, the forwarded ciphertext is re-encrypted with another random code and then sent to the receiver.

### TECHNICAL FIELD

The invention adapts a method of third party identification for protecting XOR-based cryptographic communications from security risks, wherein a sender encrypts an 1D plaintext with a 2D authorized image to obtain two ciphertexts, such that, one is sent directly to a receiver and the other is forwarded via a third party to the receiver; finally, the receiver recovers the plaintext just by XORing two ciphertexts.

### BACKGROUND ART

The Applicant's following utility patent is related to the invention and is incorporated herein by reference: “Diffusion Oriented Method and Apparatus for Stream Cryptography”, U.S. Pat. No. 8,411,852, Apr. 2, 2013.

In the prior art, a ciphertext is easily obtained from XORing both of a plaintext and a password, that implies, the password is also cracked with no effort when the intercepted ciphertext is going to XOR the leaked plaintext. Therefore, for commercial utilization, the password maintained in a safe condition has to change every time automatically on every encryption execution.

### SUMMARY OF INVENTION

The invention is not directly aimed for a plaintext XORing a password, but instead, as FIG. 1A, a sender (SR) encrypts a plaintext (im) with a two-dimension authorized image (AI) from a sand-texture generator (Fm) to obtain two one-dimension ciphertexts (im₁, im₂), and then, transmits the two ciphertexts (im₁, im₂) through different channels to a receiver (RR), and finally, the receiver (RR) obtains the plaintext (im) by XORing the two ciphertexts (im₁, im₂); the encryption and decryption process comprises the steps as below:
1. acquire an authorized image (AI);
2. input a plaintext (im);
3. generate one ciphertext (im₁), wherein im₁=im×AI;
4. generate the other ciphertext (im₂), wherein im₂=im×(AI⊕I), I: a unit matrix;
5. recover the plaintext (im), wherein im=im₁⊕im₂.

According to FIG. 1B, it clearly includes a third party (TP) in communication: a sender (SR) inputs a plaintext (im) to calculate with an authorized image (AI) to gain two ciphertexts (im₁, im₂), one (im₂) for a receiver (RR) and the other (im₁) for a third party (TP) at Step 10; the third party (TP) forwards the ciphertext (im₁) to the receiver (RR) at Step 30; the receiver (RR) recovers the plaintext (im) by XORing two ciphertexts (im₁, im₂) at Step 20. Furthermore, for building up each separate secure channel linked to a sender (SR) and to a receiver (RR), a third party (TP) in the FIG. 2 will generate two different authorized images (AI_{S}, AI_{R}) antecedently and add two random codes (im_{S}, im_{R}) throughout the encryption and the decryption.

### BRIEF DESCRIPTION OF DRAWINGS

FIG. 1A is an exemplary flowchart of encryption/decryption between a sender (SR) and a receiver (RR) in accordance with the present invention.

FIG. 1B is an exemplary flowchart further applied on FIG. 1A for including a third party (TP) in accordance with the present invention.

FIG. 2 is an exemplary flowchart further applied on FIG. 1B for including safer communications in accordance with the present invention.

FIG. 3 is an exemplary flowchart of generating a sand-texture base (F¹) wherein F¹=F (p₁, p₂, . . . , pₙ) in accordance with the present invention.

FIG. 4 is an exemplary flowchart of a sand-texture generator (F) wherein F^{m}=F (p₁, p₂, . . . , pₙ) in accordance with the present invention.

FIG. 5 is an exemplary flowchart of generating two ciphertexts (im₁, im₂) and recovering the plaintext (im) in accordance with the present invention.

FIG. 6 is an exemplary flowchart of fast detecting a sand-texture base (F¹) wherein F¹=F(p₁, p₂, . . . , pₙ) in accordance with the present invention.

FIG. 7A is an exemplary arrangement of one sand-texture base's positions (p₁, p₂, . . . , pₙ) applied on FIG. 3 in accordance with the present invention.

FIG. 7B is an exemplary uncertain number (m) with a n-bit length combined with FIG. 7A in accordance with the present invention.

FIG. 7C (left) is an exemplary picture of one sand-texture base (F¹) obtained through FIG. 7A in accordance with the present invention.

FIG. 7C (right) is an exemplary picture of one authorized image (AI_{S}) obtained through FIG. 7B in accordance with the present invention.

FIG. 8A is an exemplary arrangement of the other sand-texture base's positions (p₁, p₂, . . . , pₙ) applied on FIG. 3 in accordance with the present invention.

FIG. 8B is an exemplary uncertain number (m) with a n-bit length combined with FIG. 8A in accordance with the present invention.

FIG. 8C (left) is an exemplary picture of the other sand-texture base (F¹) obtained through FIG. 8A in accordance with the present invention.

FIG. 8C (right) is an exemplary picture of the other authorized image (AI_{R}) obtained through FIG. 8B in accordance with the present invention.

FIG. 9A is an exemplary random code (im_{S}) with a n-bit length between a sender (SR) and a third party (TP) in accordance with the present invention.

FIG. 9B is an exemplary random code (im_{R}) with a n-bit length between a receiver (RR) and a third party (TP) in accordance with the present invention.

FIG. 10A is an exemplary plaintext (im) with decimal ASCII code from a sender (SR) input in accordance with the present invention.

FIG. 10B is one exemplary ciphertext (im₁) with decimal ASCII code from a sender (SR) encryption in accordance with the present invention.

FIG. 10C is the other exemplary ciphertext (im₂) with decimal ASCII code from a sender (SR) encryption in accordance with the present invention.

FIG. 10D is an exemplary re-ciphertext (imₑ)) with decimal ASCII code from a sender (SR) re-encrypting FIG. 10B in accordance with the present invention.

FIG. 10E is an exemplary re-ciphertext (imₑ)) with decimal ASCII code from a third party (TP) re-encrypting FIG. 10B in accordance with the present invention.

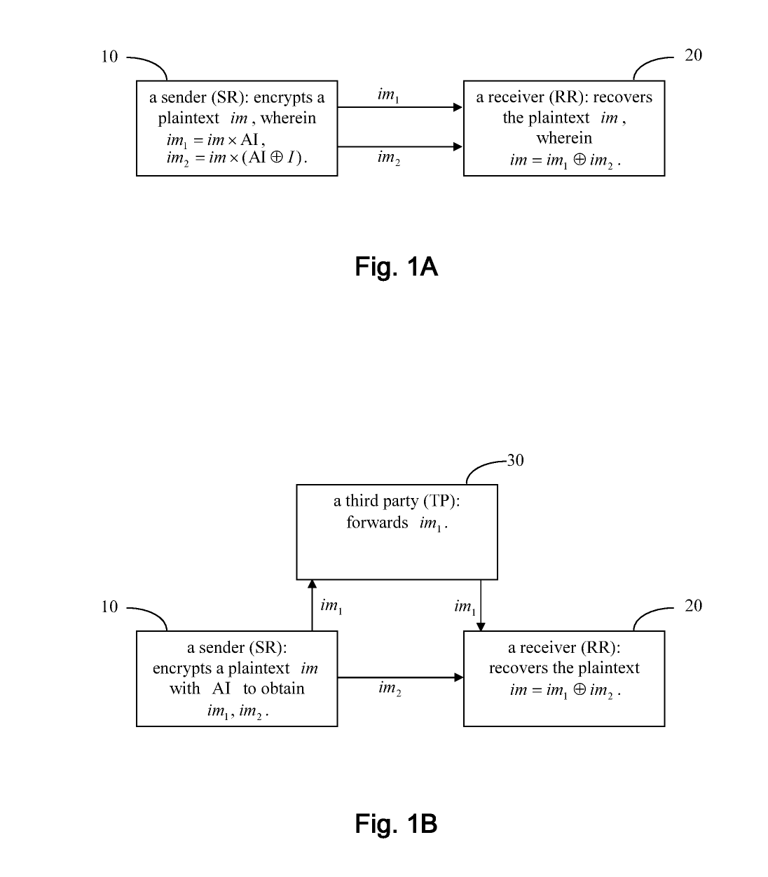

### DESCRIPTION OF EMBODYMENT

### Symbols and Definitions

According to U.S. Pat. No. 8,411,852, Columns 9-10, Parallel Process, the invention notations are simplified as below:
A: an one-dimension binary matrix, wherein the matrix (A) positions are labeled from left to right with numbers from 1 to n.
F^{m}: a sand-texture generator, wherein F^{m}=F (p₁, p₂^{m}, . . . , pₙ).

### Sand-Texture Base:

Referring to F¹=F(1:4) in U.S. Pat. No. 8,411,852, Column 10, the invention also uses F(p)=F⊕Fyₚ, as a preferred module to derive a sand-texture base (F¹); for better explanation, F¹=F(1,3,4,2,5) as an example is demonstrated as below:

$$\begin{matrix}\begin{matrix}F ( 1 ) = F ⊕ {Fy}_{1} \\ = [ \begin{matrix}10000 \\ 01000 \\ 00100 \\ 00010 \\ 00001\end{matrix} ] ⊕ [ \begin{matrix}01000 \\ 00100 \\ 00010 \\ 00001 \\ 00000\end{matrix} ] \\ = [ \begin{matrix}11000 \\ 01100 \\ 00110 \\ 00011 \\ 00001\end{matrix} ] ,\end{matrix} & \\ \begin{matrix}F ( 1 , 3 ) = F ( 1 ) ⊕ F ( 1 ) {y}_{3} \\ = [ \begin{matrix}11000 \\ 01100 \\ 00110 \\ 00011 \\ 00001\end{matrix} ] ⊕ [ \begin{matrix}10000 \\ 11010 \\ 01011 \\ 00001 \\ 00000\end{matrix} ] \\ = [ \begin{matrix}01000 \\ 10110 \\ 01101 \\ 00010 \\ 00001\end{matrix} ] ,\end{matrix} & \\ \begin{matrix}F ( 1 , 3 , 4 ) = F ( 1 , 3 ) ⊕ F ( 1 , 3 ) {y}_{4} \\ = [ \begin{matrix}01000 \\ 10110 \\ 01101 \\ 00010 \\ 00001\end{matrix} ] ⊕ [ \begin{matrix}10000 \\ 01101 \\ 11000 \\ 00101 \\ 00000\end{matrix} ] \\ = [ \begin{matrix}11000 \\ 11011 \\ 10101 \\ 00111 \\ 00001\end{matrix} ] ,\end{matrix} & \\ \begin{matrix}F ( 1 , 3 , 4 , 2 ) = F ( 1 , 3 , 4 ) ⊕ F ( 1 , 3 , 4 ) {y}_{2} \\ = [ \begin{matrix}11000 \\ 11011 \\ 10101 \\ 00111 \\ 00001\end{matrix} ] ⊕ [ \begin{matrix}10100 \\ 10101 \\ 00010 \\ 00011 \\ 00000\end{matrix} ] \\ = [ \begin{matrix}01100 \\ 01110 \\ 10111 \\ 00100 \\ 00001\end{matrix} ] ,\end{matrix} & \\ \begin{matrix}F ( 1 , 3 , 4 , 2 , 5 ) = F ( 1 , 3 , 4 , 2 ) ⊕ F ( 1 , 3 , 4 , 2 ) {y}_{5} \\ = [ \begin{matrix}01100 \\ 01110 \\ 10111 \\ 00100 \\ 00001\end{matrix} ] ⊕ [ \begin{matrix}11000 \\ 11100 \\ 01110 \\ 01000 \\ 00010\end{matrix} ] \\ = [ \begin{matrix}10100 \\ 10010 \\ 11001 \\ 01100 \\ 00011\end{matrix} ] .\end{matrix} & \end{matrix}$$

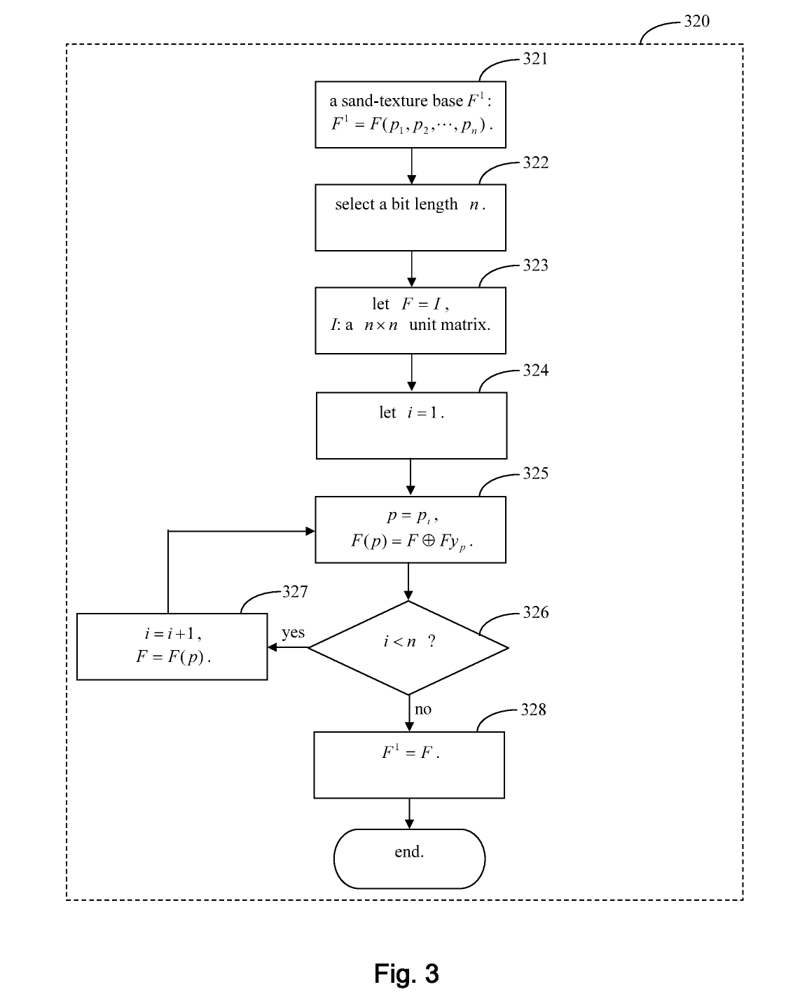

According to the above calculation in sequence, the sand-texture base (F¹) shown as FIG. 3, wherein F¹=F(p₁, p₂, . . . , pₙ), comprises the steps as below:
1. let F=I, I: a unit matrix;
2. let i=1;
3. let p=pᵢ, and then, F(p)=F⊕Fyₚ;
4. if i<n, then i=i+1, F=F(p) and go back to Step 3;
5. obtain F¹=F.

### Sand-Texture Generator:

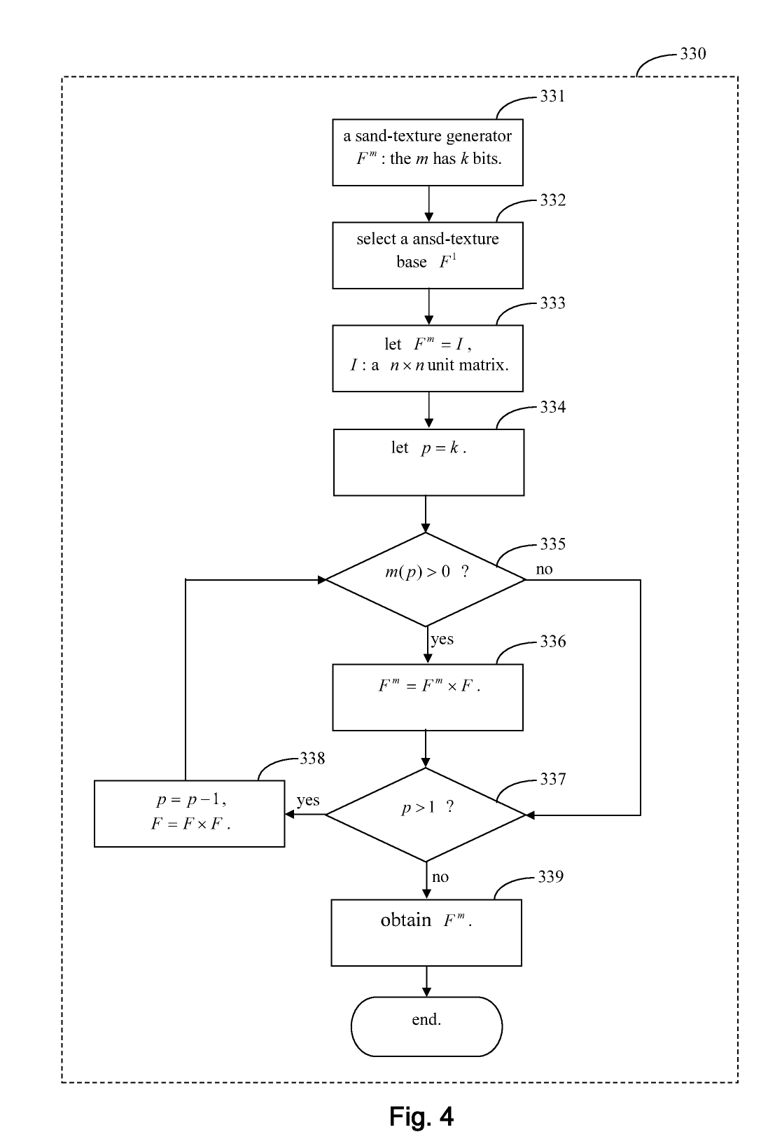

Applying with the sand-texture base (F¹), it is easy to generate any authorized image (AI) from a sand-texture generator (F^{m}) embedded with an uncertain number (m). Suppose that F¹=F(1,3,4,2,5) and m=29; the authorized image (AI) is obtained by F²⁹×F⁸×F⁴×F¹, because F^{1t}=F^{t}×F^{t} and then let 29₁₀=11101₂; therefore, the sand-texture generator (F^{m}) shown as FIG. 4, wherein F^{m}=F(p₁, p₂^{m}, . . . , pₙ) including an uncertain number (m) which has k-bit positions labeled from left to right as 1 to k, comprises the steps as below:
1. let F^{m}=I, I: a unit matrix;
2. let F=F¹, F¹: a sand-texture base;
3. let i=k
4. if m(i)>0, then F^{m}=F^{m}×F;
5. if i>1, then i=i−1, F=F×F and go back to Step 4;
6. obtain F^{m}.

According to the above steps, the authorized image (AI) is equal to

$$\begin{matrix}{F}^{29} = {F}^{1} \times {F}^{4} \times {F}^{8} \times {F}^{16} \\ = [ \begin{matrix}10100 \\ 10010 \\ 11001 \\ 01100 \\ 00011\end{matrix} ] \times [ \begin{matrix}10010 \\ 10101 \\ 01010 \\ 11100 \\ 11001\end{matrix} ] \times [ \begin{matrix}01110 \\ 00001 \\ 01001 \\ 01101 \\ 11110\end{matrix} ] \times [ \begin{matrix}00101 \\ 11110 \\ 11111 \\ 10110 \\ 01011\end{matrix} ] \\ = [ \begin{matrix}11100 \\ 10100 \\ 00011 \\ 10001 \\ 00111\end{matrix} ] .\end{matrix}$$

### Encryption and Decryption:

After working out an authorized image (AI), the method at next step will adapt the binary matrix multiplication to obtain two ciphertexts (im₁, im₂) for further decryption. Suppose that an authorized image (AI) is obtained from the above sand-texture generator (F²⁹) and a plaintext (im) is equal to 6, and then, let im=6₁₀=00110₂ and thus obtain one ciphertext (im₁) during the encryption, wherein im₁=im×AI=18 detailed as below:

$${im}_{1} = [ 00110 ] \times [ \begin{matrix}11100 \\ 10100 \\ 00011 \\ 10001 \\ 00111\end{matrix} ] = {10010}_{2} = {18}_{10} ,$$

and subsequently, obtain the other ciphertext (im₂), wherein I is a unit matrix and then im₂=im×(F²⁹⊕I)=20 detailed as below:

$${im}_{2} = [ 00110 ] \times [ \begin{matrix}01100 \\ 11100 \\ 00111 \\ 10011 \\ 00110\end{matrix} ] = {10100}_{2} = {20}_{10} ,$$

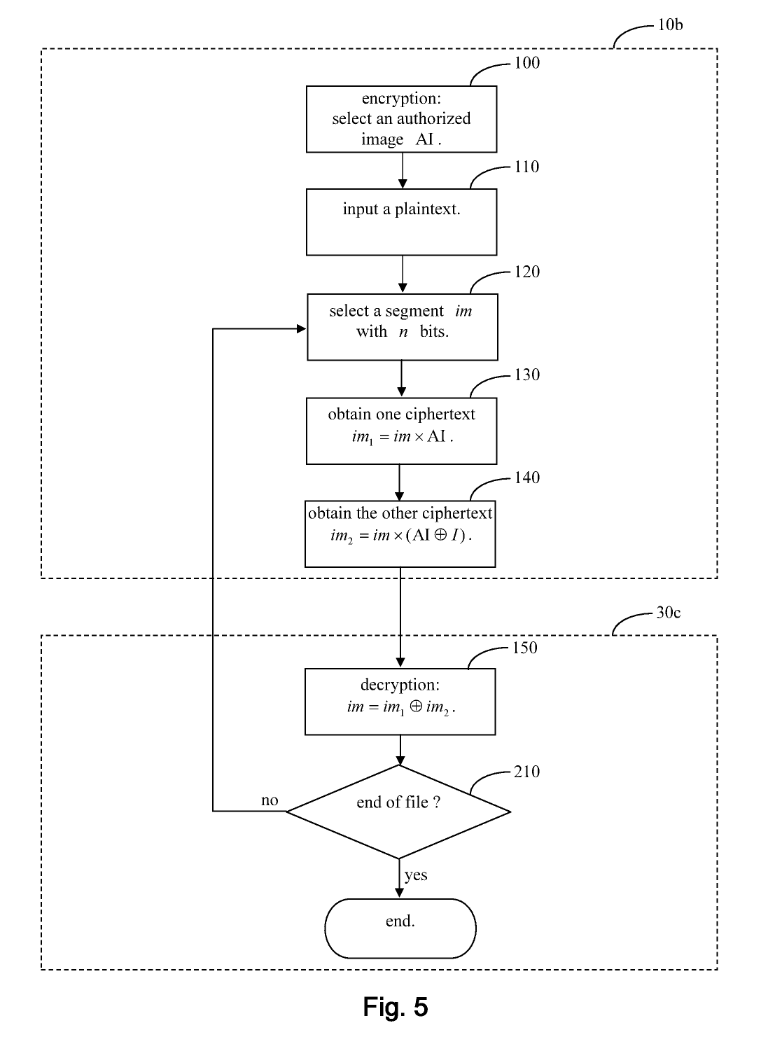

and in final, im₁⊕im₂=18₁₀⊕20₁₀=10010₂⊕010100₂=00110₂=6₁₀ under the decryption, it is very simple to recover the plaintext (im) by just combining with XOR operation; the detailed encryption and decryption in the invention, shown as FIG. 5, comprises the steps as below:
1. input a n-bit plaintext (im) in encryption;
2. select an authorized image (AI);
3. obtain one ciphertext (im₁), wherein im₁=im×AI;
4. obtain the other ciphertext (im₂), wherein im₂=im×(AI⊕I);
5. recover the plaintext (im) in decryption, wherein im=im₁⊕im₂.

### Safe Guard:

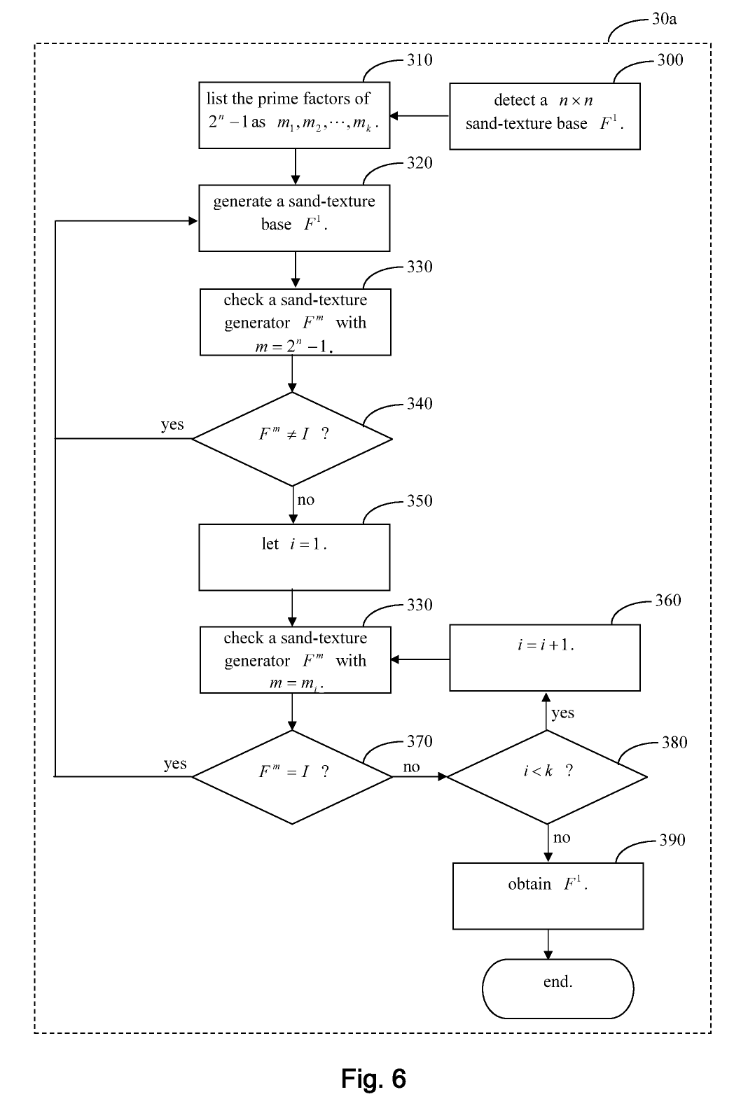

According to the size of an authorized image, there is almost no clue to find out a huge two-dimension authorized image (AI) without one-dimension plaintexts on purpose; therefore, firstly, a bigger sand-texture base (F¹) need to be created in a shorter time for a real practical application, and further, need to be complied with F²^{ⁿ}⁻¹=I, wherein the cycle of F¹ is 2ⁿ−1; and secondly, a more complicated authorized image (AI) from a sand-texture generator (F^{m}) need to designate the uncertain number (m) with more bits under a more random distribution for a higher security. The process shown as FIG. 6 for fast detecting a sand-texture base (F¹) comprises the steps as below:
1. let m₁, m₂, . . . , mₖ equate prime factors of 2ⁿ−1;
2. generate a sand-texture base (F¹), wherein F¹=F(p₁, p₂, . . . , pₙ);
3. if F²^{ⁿ}⁻¹≠1, then go back to Step 2;
4. let i=1;
5. let m=mᵢ; if F^{m}=I, then go back to Step 2;
6. if i<k, then i=i+1 and go back to Step 5;
7. obtain F¹.

According to the arrangement of a sand-texture base's positions, it is very helpful to extend diverse bases when a sand-texture base (F¹), a combination of positions (p₁, p₂, . . . , pₙ) is satisfied for F²^{ⁿ}⁻¹=I; for example, F¹=F(1,3,4,2,5) is a well-done base, such that, F(3,4,2,5,1), F(4,2,5,1,3), F(2,5,1,3,4), F(5,1,3,4,2), each one related to the position rotation is also a suitable base; furthermore, it may say F¹=F( 1̅, 3̅, 4̅, 2̅, 3̅) is a well-done base too, wherein 3̅=n−3+1=3 for an example, that is to say, F¹=F(5,3,2,4,1) is an option, and thus, by working on the position rotation, F(3,2,4,1,5), F(2,4,1,5,3), F(4,1,5,3,2), F(1,5,3,2,4), each one is also an option. So according to that, a third party (TP) may create a sand-texture base (F¹) quickly and obtain the multiple bases easily at same time, and thus, may remark those as a series of label numbers (#) simply, e.g., F(1,3,4,2,5) as “01”, F(5,3,2,4,1) as “11”, and then, F(3,4,2,5,1) as “02”, F(3,2,4,1,5) as “12”, and so forth.

In addition, it is beneficial that a third party (TP) may back up the original base's positions (p₁, p₂, . . . , pₙ) in one database; and further, back up every client's (SR, RR) own authorized image (AI), wherein it may be represented by a combination of a label number (#) and an uncertain number (m), and extra back up the transmitted ciphertexts (im₁) in communication to another database. Therefore, the third party (TP) will not leak the plaintext (im) without acquiring the administrative privileges of the two databases, and in other words, the third party (TP) also has a lawful permission to recover the plaintext (im) by im₁×F²^{ⁿ}^{-m-1} for message verification in the future; one ciphertext (im₁) for an example, wherein im₁=im×AI=18 from the above demonstration and the authorized image (AI) is obtained by a sand-texture generator

$${F}^{29} = F {( 1 , 3 , 4 , 2 , 5 )}^{29} ,$$

the plaintext (im) is verified as below:

$$\begin{matrix}im = {im}_{1} \times {F}^{{2}^{n} - m - 1} \\ = {im}_{1} \times {F}^{2} \\ = [ 10010 ] \times [ \begin{matrix}01101 \\ 11000 \\ 00101 \\ 01011 \\ 01111\end{matrix} ] \\ = {00110}_{2} \\ = {6}_{10}\end{matrix}$$

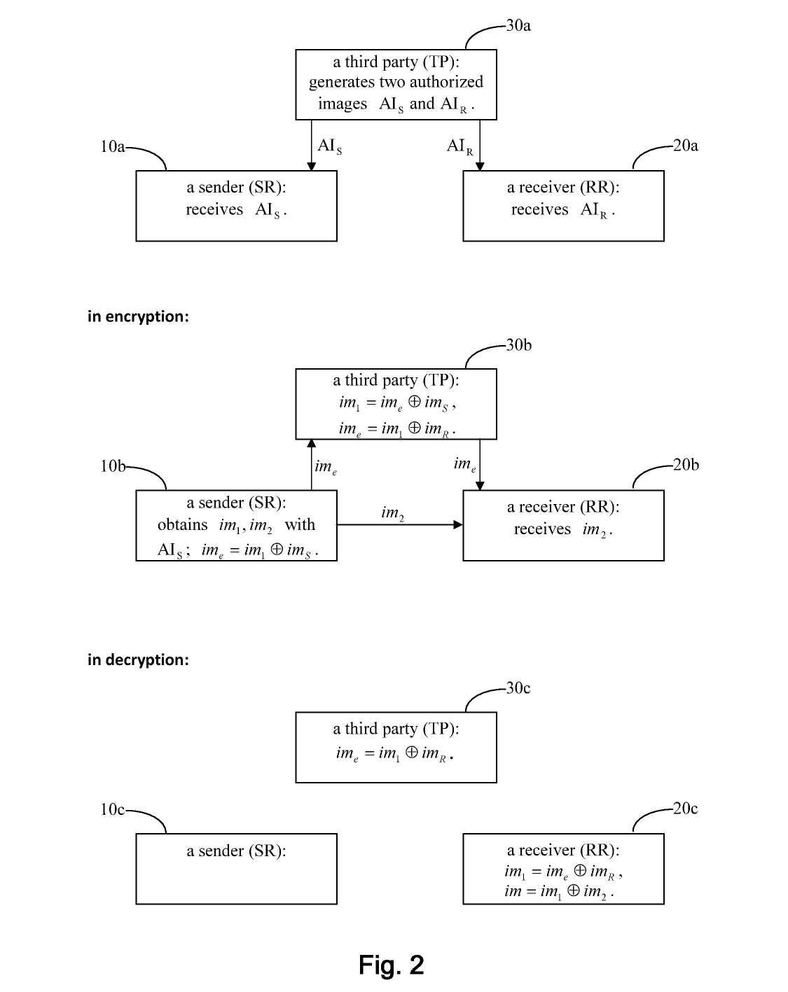

According to the transmitting ciphertexts on channels, firstly, if there is a heedless plaintext (im) only existing value 1 at a single bit position, then it will be careless to leak the partial or whole authorized image (AI); secondly, if two ciphertexts (im₁, im₂) are intercepted on transmitting channels, then the plaintext (im) is cracked subsequently; therefore, a third party (TP) joins into the connection between a sender (SR) and a receiver (RR), wherein the third party (TP) is responsible for publishing the authorized images (AI) and further supporting more security on channels with n-bit random codes (im_{S}, im_{R}); the transmission on channels also referred to FIG. 2 comprises the steps as below:

a sender (SR):
1. input a plaintext (im); obtain two ciphertexts (im₁, im₂);
2. re-encrypt im₁, wherein imₑ=im₁⊕im_{S}, im_{S}: a random code;
3. send imₑ to a third party (TP); send im₂ to a receiver (RR);

a third party (TP):
4. receive imₑ from the sender (SR) and let im₁=imₑ⊕im_{S};
5. re-encrypt im₁, wherein imₑ=im₁⊕im_{R}, im_{R}: a random code;
6. send imₑ to the receiver (RR);

a receiver (RR):
7. receive im₂ from the sender (SR);
8. receive imₑ from the third party (TP) and let im₁=imₑ⊕im_{R};
9. recover the plaintext (im), wherein im=im₁⊕im₂.

According to the transmitting channel itself, firstly, a third party (TP) publishes various authorized images (AI) for network clients to build up the communication, wherein every authorized image (AI) is equivalent to a client identification in private; secondly, the third party (TP) may also publish the random codes (im_{S}, im_{R}) separately to XOR the first ciphertext (im₁) from a sender (SR) via a third party (TP) to a receiver (RR) for safer protection. Therefore, at startup in communication, each authorized image (AI) or the random codes (im_{S}, im_{R}) may be sent through a secure channel, such as SSL (Secure Socket Layer) or PKI (Public Key Infrastructure); alternatively, the application Ser. No. 12/287,372, “Asymmetric encryption/decryption method”, Chiou-Haun Lee, submitted on Oct. 8, 2010: each client may choose a modulus number n, and then, generate a pair of public and private key by 2ⁱ and ½ⁱ at page 4, it may create its own private channel in no time.

### Preferred Embodiment

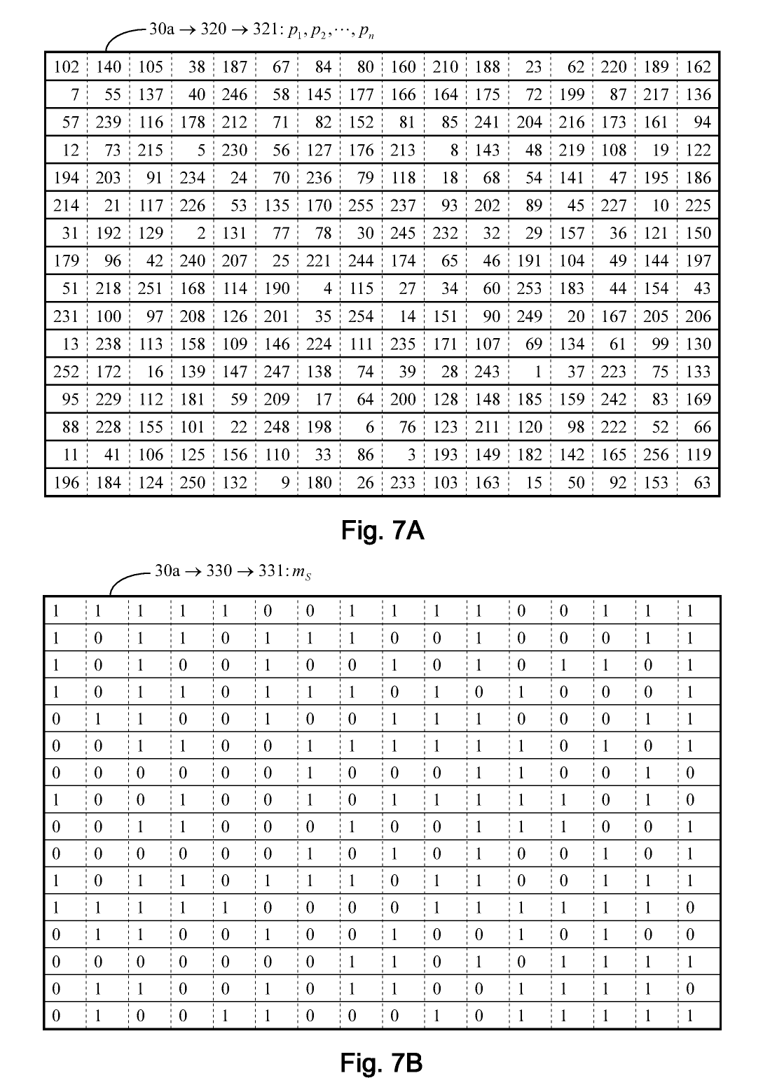

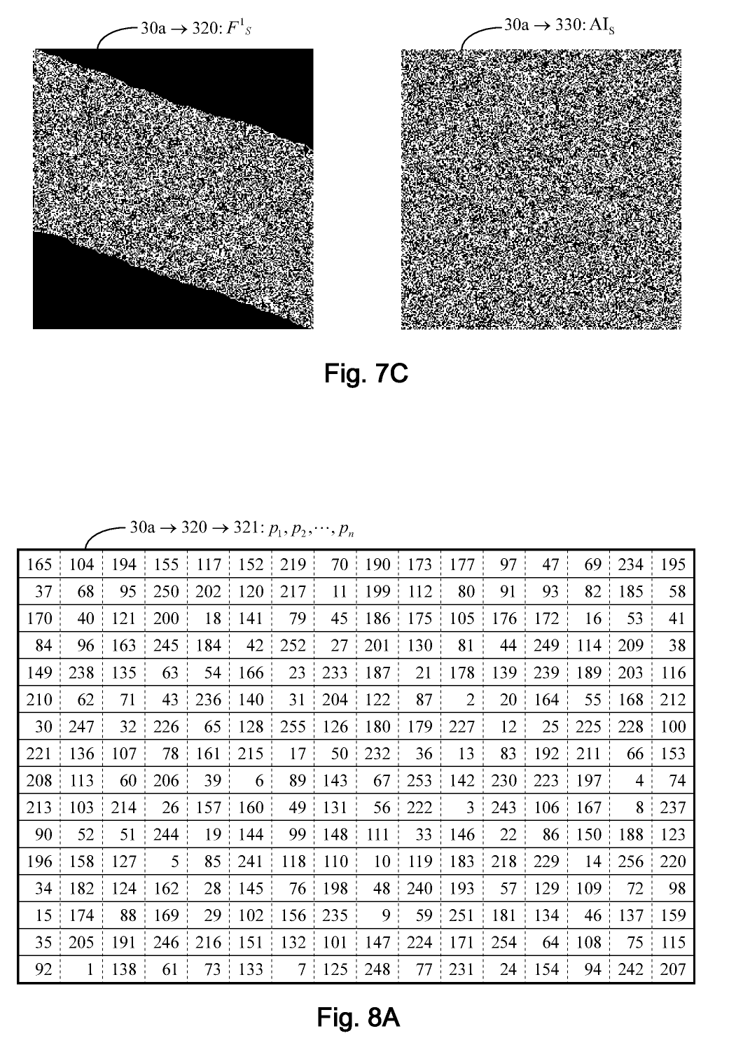

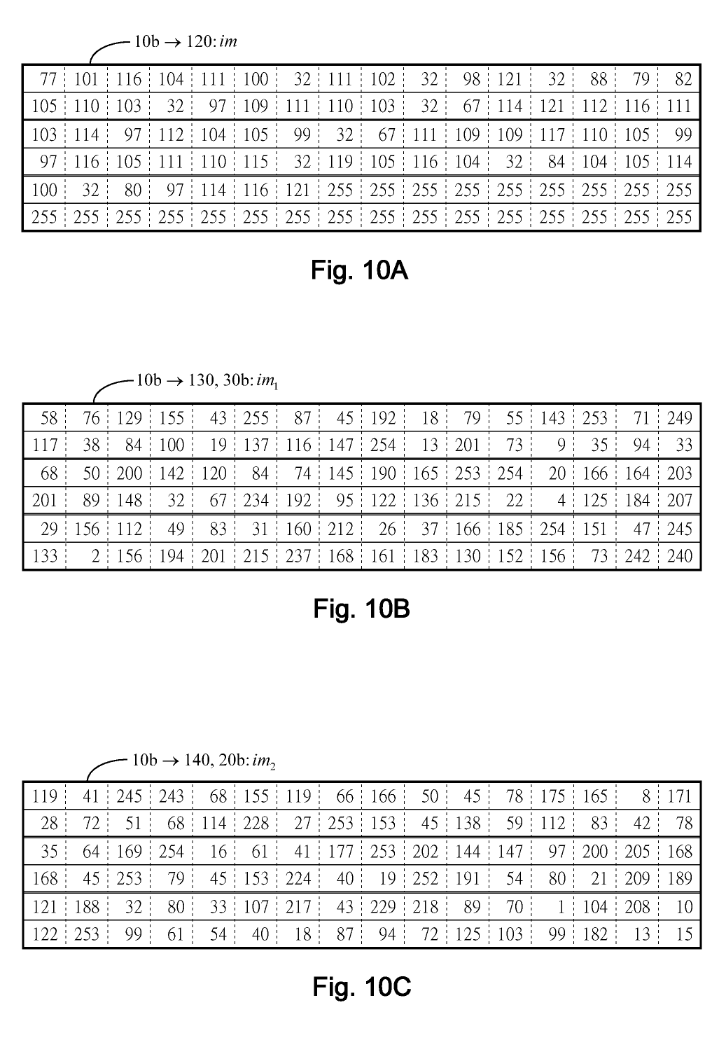

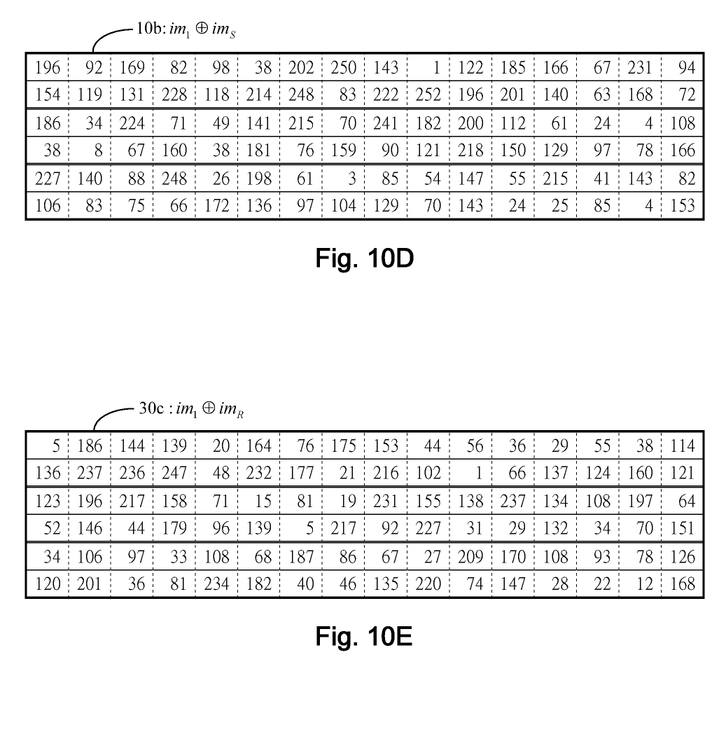

In a practical application, the preferred embodiment takes upon 32 bytes as one segment, equally, n=256 bits; the demonstrated data are shown from FIG. 7* to FIG. 10*, wherein the positions are arranged from left to right, and then, from up to down; the demonstrated procedure is corresponding to FIG. 2.

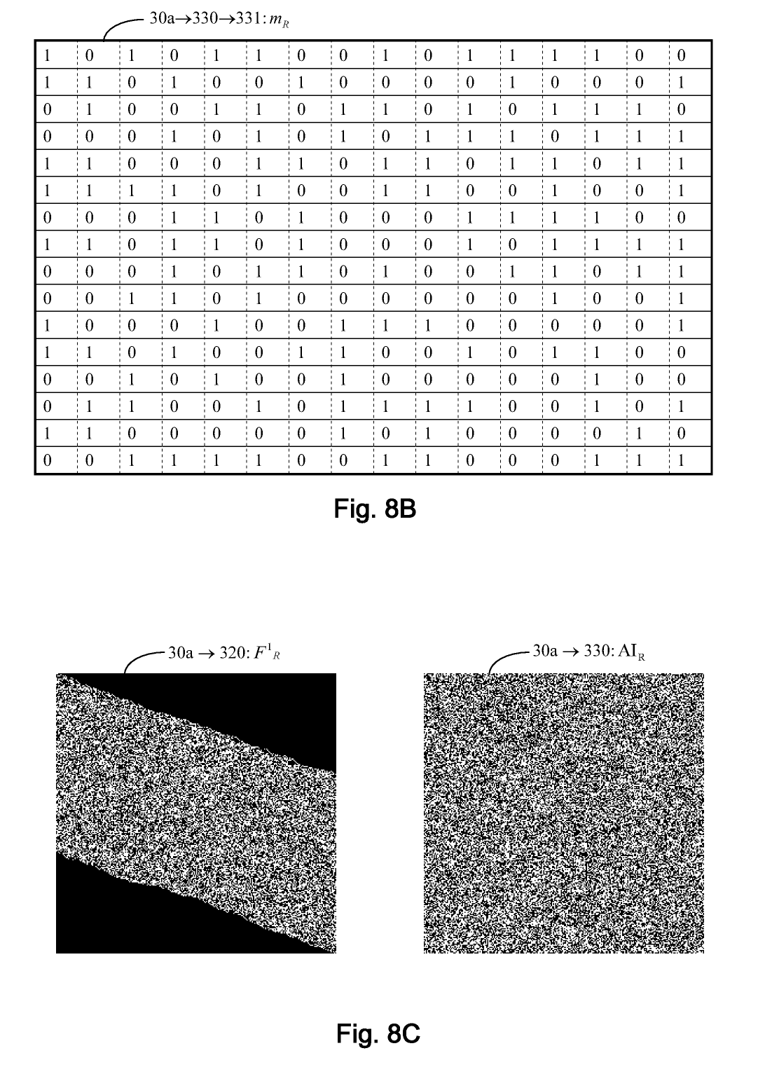

at startup: a third party (TP) therein
1. detect two sand-texture bases (F¹): according to F¹=F(p₁, p₂, . . . , pₙ), FIG. 6, the third party (TP) obtains one base (F¹s) as the left of FIG. 7C through one's positions (p₁, p₂, . . . pₙ), as FIG. 7A and the other base (F¹R) as the left of FIG. 8C through another's positions (n p₂, as FIG. 8A;
2. generate two authorized images (AI): according to F^{m}=F(p₁, p₂^{m}, . . . , pₙ), FIG. 4, the third party (TP) obtains one authorized image (AI_{S}) as the right of FIG. 7C through one uncertain number (m=m_{S}) as FIG. 7B and the other authorized image (AI_{R}) as the right of FIG. 8C through the other uncertain number (m=m_{R}) as FIG. 8B;
3. send two authorized images (AI): the third party (TP) transmits one authorized image (AI_{S}) to a sender (SR) and transmits the other authorized image (AI_{R}) to a receiver (RR).
   z in encryption: a sender (SR) therein

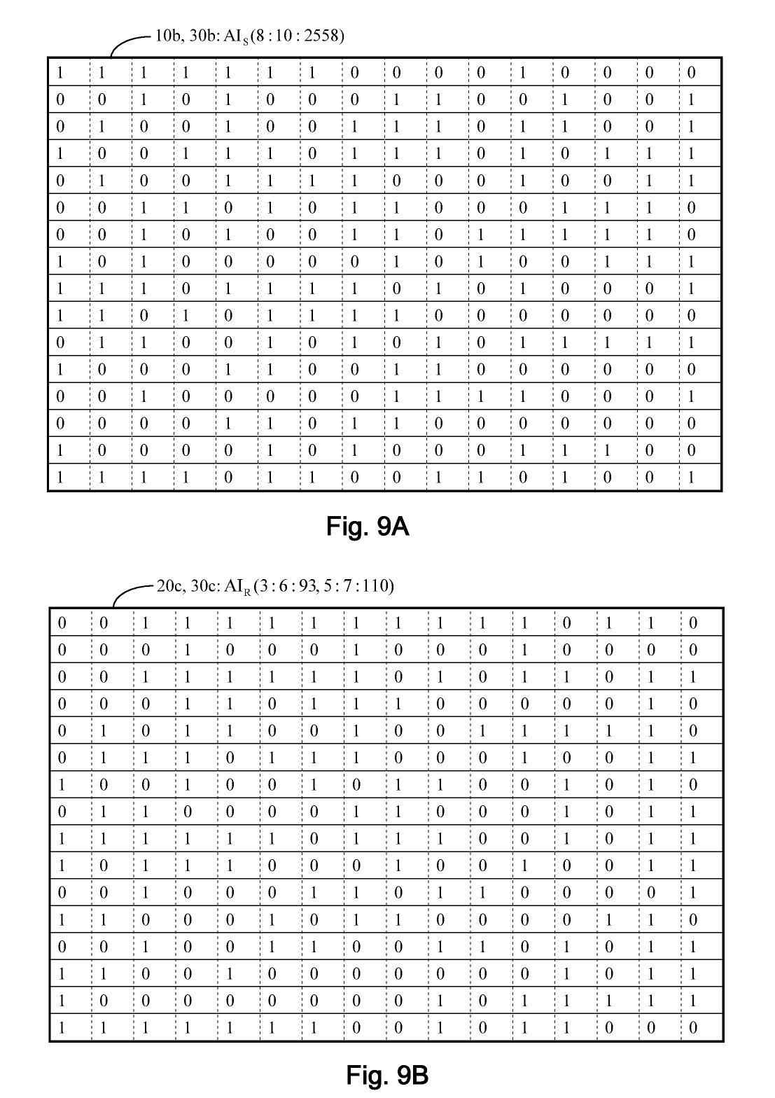

Suppose that a plaintext is “Method of by XORing among Cryptographic Communications with Third Party”, therefore, the plaintext is divided into three segments in sequence “Method of by XORing among Crypto”, “graphic Communications with Thir” and “d Partyyyyyyyyyyyyymyyyyymyy” as FIG. 10A in decimal ASCII code, wherein the last segment is filled to 32 bytes with a character ‘y’, i.e., 255 in decimal ASCII representation.
1. encrypt the plaintext segments (im): according to FIG. 5, the sender (SR) obtains one ciphertext (im₁) as FIG. 10B, wherein im₁=im×AI_{S}, and the other ciphertext (im₂) as FIG. 10C, wherein im₂=im×(AI_{S}⊕I);
2. re-encrypt one ciphertext (im₁): the sender (SR) obtains the re-ciphertext (imₑ), wherein imₑ=imᵢ⊕im_{S}, im_{S}: a random code as FIG. 9A obtained from one authorized image (AI_{S}) on positions (8:10:8+10×255), equally, from position 8 to 2558 at an interval of 10;
3. send two ciphertexts (imₑ, im₂): the sender (SR) transmits the re-ciphertext (imₑ) as FIG. 10D plus the random code's (im_{S}) positions to the third party (TP) and transmits the other ciphertext (im₂) to the receiver (RR).
   in decryption: a receiver (RR) therein
1. receive one ciphertext (imₑ): the receiver (RR) gets the re-ciphertext (imₑ) as FIG. 10E plus the random code's (im_{R}) positions from the third party (TP); according to FIG. 2, 30b, the third party (TP) recovers one ciphertext (im₁), wherein im₁=imₑ⊕im_{S}, im_{S}=AI_{S} (8:10:8+10×255), and then, re-encrypts the ciphertext (im₁) again, wherein the re-ciphertext (imₑ) is obtained by letting imₑ=im₁⊕im_{R}, im_{R}: a random code as FIG. 9B gained from the other authorized image (AI_{R}) on positions (3:6:3+6*15, 5:7:5+7*15), equally, from row position 3 to 93 at an interval of 6, correspondingly, from column position 5 to 110 at an interval of 7, and finally, the third party (TP) sends the re-ciphertext (imₑ) plus the random code's (im_{R}) positions to the receiver (RR);
2. receive the other ciphertext (im₂): the receiver (RR) gets the other ciphertext (im₂) from the sender (SR);
3. recover the plaintext segments (im): the receiver (RR) restores one ciphertext (im₁), wherein im₁=imₑ⊕im_{R}, im_{R}=AI_{R} (3:6:3+6*15, 5:7:5+7*15), and then, restores the plaintext segments (im), wherein im=im₁⊕im₂.

In summation of the above description, the present invention herein complies with the constitutional, statutory, regulatory and treaty patent application requirements and is herewith submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of third party identification for cryptographic communications, the method includes at least one third party (TP), wherein the third party (TP) run by a computer comprises at least one step as below:
(a) generate at least one sand-texture base (F¹), wherein the sand-texture base (F¹) is performed by letting F¹=F(p₁, p₂, . . . , pₙ) which complied with F²^{ⁿ}⁻¹=I, I: a unit matrix; in addition, a combination of the sand-texture base's positions (p₁, p₂, . . . , pₙ) may be backed up in one database, and further, remarked as a label number (#);
(b) generate at least one authorized image (AI), wherein the authorized image (AI) is obtained from a sand-texture generator (F^{m}), wherein F^{m}=F(p₁, p₂, . . . , pₙ), equally, the sand-texture base (F¹) run for an uncertain number (m) times;
(c) send every authorized image (AI) in cryptographic communications for identification.

2. The method according to claim 1, wherein the method further includes at least one sender (SR), wherein the sender (SR) run by a computer comprises at least one step as below:
(a) receive one authorized image (AI_{S}) from the third party (TP);
(b) input at least one n-bit plaintext segment (im);
(c) generate one ciphertext (im₁) sent to the third party (TP), wherein im₁=im×AI_{S}, and generate the other ciphertext (im₂) sent to a receiver (RR), wherein im₂=im×(AI_{S}⊕I).

3. The method according to claim 2, wherein the method further includes at least one receiver (RR), wherein the receiver (RR) run by a computer comprises at least one step as below:
(a) receive the other authorized image (AI_{R}) from the third party (TP);
(b) receive one ciphertext (im₁) from the third party (TP) and receive the other ciphertext (im₂) from the sender (SR);
(c) recover the multiple plaintext segments (im), wherein im=im₁⊕im₂.

4. The method according to claim 2, wherein every plaintext segment (im) comprises multiple bits with value 1.

5. The method according to claim 1, wherein the sand-texture base (F¹) is performed by comprising the steps as below:
(a) let F=I;
(b) let i=1;
(c) let p=pᵢ, and then, F(p)=F⊕Fyₚ;
(d) if i<n, then i=i+1, F=F(p) and go back to Step (c);
(e) obtain F¹.

6. The method according to claim 1, wherein the uncertain number (m) has k-bit positions labeled from left to right as 1 to k; the sand-texture generator (Fm) is performed by comprising the steps as below:
(a) let F^{m}=I;
(b) let F=F¹ and i=k:
(c) if m(i)>0, then F^{m}=F^{m}×F;
(d) if i>1, then i=i−1, F=F×F and go back to Step (c);
(e) obtain F^{m}.

7. The method according to claim 1, wherein the sand-texture base (F¹) is detected quickly by comprising the steps as below:
(a) let m₁, m₂, . . . , mₖ equate the prime factors of 2ⁿ−1;
(b) generate a sand-texture base (F¹) wherein F¹=F(p₁, p₂, . . . , pₙ);
(c) if F²^{ⁿ}⁻¹≠I, then go back to Step (b);
(d) let i=1;
(e) let m=mᵢ; if F^{m}=I, then go back to Step (b);
(0 if i<k, then i=i+1 and go back to Step (e);
(g) obtain F¹.

8. The method according to claim 7, wherein the sand-texture base's positions (p₁, p₂, . . . , pₙ) is adequate to generate another sand-texture bases by working on the position rotation, such as the sand-texture base's F(p₁, p₂, . . . , pₙ) positions being reassigned to positions (p₂, . . . , pₙ, p₁); and further, the sand-texture base's F(p₁, p₂, . . . , pₙ) positions may be reassigned to positions ( p̅₁, p̅₂, . . . , p̅ₙ), wherein p̅_{*}=n−p_{*}+1; there will be a number of 2×n combinations of sand-texture base's positions, wherein the 2×n combinations are remarked as a series of the label numbers (#) in total.

9. The method according to claim 3, wherein through the communication from the sender (SR) via the third party (TP) to the receiver (RR), every client's authorized image (AI) which is represented by a combination of the label number (#) and the uncertain number (m), and extra, the transmitted ciphertexts (im₁) may be backed up to another database.

10. The method according to claim 9, wherein the third party (TP) will not leak the multiple plaintext segments (im) without acquiring the administrative privileges of the two databases; in other words, the third party (TP) has a lawful permission to recover the multiple plaintext segments (inn), wherein inn=im₁×F²^{ⁿ}^{-m-1}, for message verification in the future.

11. The method according to claim 2, wherein for transmitting the ciphertext (im₁) safely, the sender (SR) sends a re-ciphertext (imₑ) in which imₑ=im₁⊕im_{S} to the third party (TP), and then, the third party (TP) obtains the ciphertext (im₁), wherein im₁=imₑ⊕im_{S}, im_{S}: a n-bit random code.

12. The method according to claim 3, wherein for transmitting the ciphertext (im₁) safely, the third party (TP) sends a re-ciphertext (imₑ)) in which imₑ=im₁⊕im_{R} to the receiver (RR), and then, the receiver (RR) obtains the ciphertext (im₁), wherein im₁=imₑ⊕im_{R}, im_{R}: a n-bit random code.

13. The method according to claim 11, wherein the third party (TP) may transmit the one authorized image (AI_{S}) or the n-bit random code (im_{S}) through a secure channel, such as SSL (Secure Socket Layer) or PKI (Public Key Infrastructure).

14. The method according to claim 11, wherein the sender (SR) obtains the n-bit random code (im_{S}) from a number of n assigned positions of the authorized image (AI_{S}), and thus, the sender (SR) further transmits the assigned n positions labeled as a short math expression to the third party (TP).

15. The method according to claim 14, wherein the sender (SR) changes the assigned n positions at least one time during the ciphertext (im₁) encryption.

16. The method according to claim 12, wherein the third party (TP) may transmit the other authorized image (AI_{R}) or the n-bit random code (im_{R}) through a secure channel, such as SSL (Secure Socket Layer) or PKI (Public Key Infrastructure).

17. The method according to claim 12, wherein the third party (TP) obtains the n-bit random code (im_{R}) from a number of n assigned positions of the authorized image (AI_{R}), and thus, the third party (TP) further transmits the assigned n positions labeled as a short math expression to the receiver (RR).

18. The method according to claim 17, wherein the third party (TP) changes the assigned n positions at least one time during the ciphertext (im₁) encryption.
